(19) United States
(12) Patent Application Publication
(10) Pub. No.: US 2024/0152762 A1
(43) Pub. Date: May 9, 2024

(54) METHOD AND APPARATUS FOR ANALYZING MULTI-TARGET BASED ON REINFORCEMENT LEARNING FOR LEARNING UNDER-EXPLORED TARGET

(71) Applicant: SEOUL NATIONAL UNIVERSITY R&DB FOUNDATION, Seoul (KR)

(72) Inventors: Byoung-Tak ZHANG, Seoul (KR); Kibeom KIM, Seoul (KR); Hyundo LEE, Seoul (KR); Min Whoo LEE, Seoul (KR); Dong-Sig HAN, Seoul (KR); Minsu LEE, Seoul (KR)

(73) Assignee: SEOUL NATIONAL UNIVERSITY R&DB FOUNDATION, Seoul (KR)

(21) Appl. No.: 18/491,020

(22) Filed: Oct. 20, 2023

(30) Foreign Application Priority Data
Oct. 26, 2022 (KR) 10-2022-0139641

(51) Int. Cl. G06N 3/092

(52) U.S. Cl. CPC G06N 3/092

(57) ABSTRACT

Disclosed herein are a multi-target analysis apparatus and method. The multi-target analysis apparatus includes: an input/output interface configured to receive data and output the results of computation of the data; storage configured to store a program for performing a multi-target analysis method; and a controller provided with at least one process, and configured to analyze multiple targets received through the input/output interface by executing the program. The controller is further configured to: collect instruction-target pairs in each of which an instruction and state information for a target are matched with each other so that the target is specified through the instruction, and generate an instruction-target set having a plurality of instruction-target pairs; and train a reinforcement learning-based learning model configured to receive the instruction for the target and the state information for the target and output action information by referring to the instruction-target set.

### CROSS-REFERENCE TO RELATED APPLICATION

This application claims the benefit of Korean Patent Application No. 10-2022-0139641 filed on Oct. 26, 2022, which is hereby incorporated by reference herein in its entirety.

### BACKGROUND

### 1. Technical Field

The embodiments disclosed herein generally relate to a multi-target analysis method and apparatus, and more particularly, to a multi-target analysis method and apparatus capable of performing data collection and learning for multiple targets having different success rates.

The embodiments disclosed herein were derived as a result of the research on the task “(SW Star Lab) Cognitive Agents That Learn Everyday Life (IITP-2015-0-00310-008)” of the SW Computing Industry Source Technology Development Project, the task “Development of Brain-inspired AI with Human-like Intelligence (task management number: IITP-2019-0-01371-004)” of the Innovative Growth Engine Project, the task “Artificial Intelligence Innovation Hub (task management number: IITP-2021-0-02068-002)” of the ICT and Broadcasting Innovation Talent Fostering Project, the task “Development of Uncertainty-Aware Agents Learning by Asking Questions (task management number: IITP-2022-0-00951-001)” of the Human-Centered Artificial Intelligence Core Technology Development Project, and the task “Self-directed AI Agents with Problem-solving Capability (task management number: IITP-2022-0-00953-001)” of the Human-Centered Artificial Intelligence Core Technology Development Project sponsored by the Korean Ministry of Science and ICT and the Institute of Information & Communications Technology Planning & Evaluation (IITP).

The embodiments disclosed herein were derived as a result of the research on the task “Goal-oriented Self-supervised Reinforcement Learning for Real-world Applications (task management number: NRF-2021R1A2C1010970)” of the Personal Basic Research Project sponsored by the Korean Ministry of Science and ICT and the National Research Foundation of Korea (NRF).

### 2. Description of the Related Art

A task that targets and interacts with various goals is called a multi-target task. In this case, such targets may correspond to various objects or places. Existing learning methods for learning a multi-target task include the technologies disclosed in non-patent document 1 (Kim, Kibeom, et al. “Goal-Aware Cross-Entropy for Multi-Target Reinforcement Learning.” Advances in Neural Information Processing Systems 35 (2021)) and non-patent document 2 (Andrychowicz, Marcin, et al. “Hindsight Experience Replay.” Advances in neural information processing systems 31 (2017)).

The learning method according to non-patent document 1 is performed in such a manner that visual information for targets is separately stored for success data acquired during learning through trial and error and a model is trained on the corresponding targets through any sampling technique. The learning method according to non-patent document 1 is configured to collect data for each target in the process of learning a multi-target task and update cognitive learning for the collected target data together with a reinforcement learning policy. According to the learning method according to non-patent document 1, even in a case where a difference occurs between the success rates of targets, a situation in which the success data of a target having a low difficulty level dominates occurs. A target having a high difficulty level is in fact rarely sampled, is excluded from training, and fails. In other words, a target having a high difficulty level may become an under-explored target.

The learning method according to non-patent document 2 is designed to adjust a failed trajectory to a successful trajectory by performing target relabeling on the failed trajectory and then adjusting a target state, thereby acquiring success data and performing learning. The learning method according to non-patent document 2 requires the assumption that a target state can be adjusted. In a situation in which different targets are target states, it is not easy to change a target state through adjustment, and thus the application of this learning method to a multi-target environment having different difficulty levels is limited.

### SUMMARY

An object of the embodiments disclosed herein is to provide a multi-target method and apparatus that, when there is a difference in difficulty between targets in a situation in which the targets are specified through instructions in a multi-target environment, perform reinforcement learning through a method of adjusting the sampling rate of a target having a high difficulty level and setting instructions so that the target is not excluded from learning, thereby improving success rate and sampling efficiency.

Other objects and advantages of the present invention can be understood from the following description, and will be more clearly understood by embodiments. It will also be readily apparent that the objects and advantages of the present invention may be realized by the means set forth in the claims and combinations thereof.

As a technical solution for accomplishing the above objects, there is provided a multi-target analysis apparatus including: an input/output interface configured to receive data and output the results of computation of the data; storage configured to store a program for performing a multi-target analysis method; and a controller provided with at least one process, and configured to analyze multiple targets received through the input/output interface by executing the program; wherein the controller is further configured to: collect instruction-target pairs in each of which an instruction and state information for a target are matched with each other so that the target is specified through the instruction, and generate an instruction-target set having a plurality of instruction-target pairs; and train a reinforcement learning-based learning model configured to receive the instruction for the target and the state information for the target and output action information by referring to the instruction-target set.

According to an aspect of the present invention, there is provided a multi-target analysis method that is performed by a multi-target analysis apparatus, the multi-target analysis method including: collecting instruction-target pairs in each of which an instruction and state information for a target are matched with each other so that the target is specified through the instruction, and storing an instruction-target set having a plurality of instruction-target pairs; and training a reinforcement learning-based learning model configured to receive the instruction for the target and the state information for the target and output action information by referring to the instruction-target set.

According to another aspect of the present invention, there is provided a non-transitory computer-readable storage medium having stored thereon a program that, when executed by a processor, causes the processor to execute the multi-target analysis method.

According to another aspect of the present invention, there is provided a computer program that is executed by a multi-target analysis apparatus and stored in a non-transitory computer-readable storage medium in order to perform the multi-target analysis method.

### BRIEF DESCRIPTION OF THE DRAWINGS

The above and other objects, features, and advantages of the present invention will be more clearly understood from the following detailed description taken in conjunction with the accompanying drawings, in which:

FIG. 1 is a diagram illustrating target success rates in a multi-target environment;

FIG. 2 is a function block diagram of a multi-target analysis apparatus according to an embodiment;

FIG. 3 is a diagram illustrating the operation and data flow of a reinforcement learning-based learning model applied to a multi-target analysis apparatus according to an embodiment;

FIG. 4 is a diagram illustrating target-attentive curricular sampling and active self-querying that are performed by a multi-target analysis apparatus according to an embodiment;

FIG. 5 is a flowchart illustrating an overall learning operation that is performed by a multi-target analysis apparatus according to an embodiment;

FIGS. 6 and 7 are flowcharts illustrating a multi-target analysis method according to another embodiment; and

FIGS. 8 to 10 are diagrams illustrating success rates of multiple targets simulated according to embodiments.

### DETAILED DESCRIPTION

Various embodiments will be described in detail below with reference to the accompanying drawings. The following embodiments may be modified to various different forms and then practiced. In order to more clearly illustrate features of the embodiments, detailed descriptions of items that are well known to those having ordinary skill in the art to which the following embodiments pertain will be omitted. Furthermore, in the drawings, portions unrelated to descriptions of the embodiments will be omitted. Throughout the specification, like reference symbols will be assigned to like portions.

Throughout the specification, when one component is described as being “connected” to another component, this includes not only a case where the one component is “directly connected” to the other component but also a case where the one component is “connected to the other component with a third component arranged therebetween.” Furthermore, when one portion is described as “including” one component, this does not mean that the portion does not exclude another component but means that the portion may further include another component, unless explicitly described to the contrary.

Embodiments will be described in detail below with reference to the accompanying drawings.

Reinforcement learning is machine learning that performs learning based on experience through interactions and selects actions or action sequences that maximize rewards. Reinforcement learning is designed to recognize states, perform actions according to policies, and obtain rewards in a given environment. This is called model-free reinforcement learning because the next state cannot be known in advance. Representative deep learning-based model-free reinforcement learning algorithms include Deep Q-Networks (DQN), Asynchronous Advantage Actor Critic (A3C), Proximal Policy Optimization (PPO), etc.

An agent, which is the subject of reinforcement learning, learns a decision-making strategy that maximizes rewards, and the ultimate goal thereof is to maximize the expected value of the sum of rewards. That is, the agent is trained to select the optimal actions that give the highest rewards.

In reinforcement learning, sampling is performed because it is not possible to determine values for all states. The agent learns an environment by experiencing these samples.

An episode of reinforcement learning refers to a series of processes of the states, actions, and rewards that an agent has gone through from an initial state to an end state. In reinforcement learning, when an episode ends, information about actions performed in past states is recorded. Recorded information is a kind of experience. Recorded information is used to make decisions in the next episode. After an episode ends, the process of recording and updating the information obtained through the episode is repeated.

The way that a reinforcement learning agent makes decisions is called policies. Most deep learning-based reinforcement learning algorithms require a lot of trial and error to learn policies. Nevertheless, there are many cases in which high learning performance is not achieved. One of the reasons for this is that learning about the goal, which plays a decisive role in solving a task, is not performed together. During learning, a goal is reached through trial and error with difficulty, but it is not directly learned, resulting in inefficient learning that requires a lot of training data.

In multi-target reinforcement learning, when there are two or more different targets, a reinforcement learning task such as navigation is performed through a method in which a goal in a corresponding episode is determined through an instruction. A goal to be performed by an agent corresponds to a target task. Examples of instructions in multi-target tasks may include not only actions related to daily life, such as “get a cup” or “go to the living room,” but also various actions required for the design purpose of an agent (e.g., a robot).

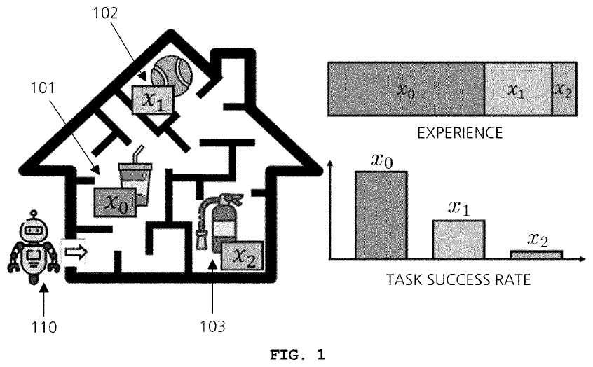

FIG. 1 is a diagram illustrating target success rates in a multi-target environment.

When a goal easy for an agent to succeed in and a goal difficult for the agent to succeed in are present together, the success experience of the agent may be dominated by the easy goal. The unbalanced success experience leads to insufficient learning about or exclusion from interactions with the difficult target.

For example, it is assumed that referring to FIG. 1, in a household robot scenario, there are a cup 101 and a ball 102, which are easy objects located close to the initial position of a robot 110, and there is a fire extinguisher 103, which is a difficult target always located far from the position of the robot 110. The robot 110 is asked to fetch the cup 101 or the ball 102 more often, and is asked to fetch the fire extinguisher 103 considerably rarely. In this case, it is difficult to perform successful learning because a target such as the fire extinguisher 103 is not appropriately explored due to unbalanced experience. This means that a previously unseen target or a newly added target does not have a chance to be learned during a learning process.

The present embodiment attempts to overcome the under-explored target problem (UTP) as an important problem to be dealt with in a multi-target task. The under-explored target problem is a phenomenon in which a specific target that is difficult to access or interact with during the performance of a task is neglected in or excluded from a learning process.

The present embodiment mitigates problems in three major aspects by applying Learning, Sampling, Active self-querying (L-SA) in order to overcome the under-explored target problem.

First, presentation learning is performed for target discrimination. In a multi-target environment, it is necessary to differentiate targets, which are goals. To this end, representation learning for goals is performed using supervised contrastive learning. When supervised contrastive learning is applied, the number of targets in a multi-target task is not required in advance, so that flexible handling can be performed in a multi-target environment.

Second, there is applied Target-Attentive Curricular Sampling (TACS), which constructs training data for target discrimination while focusing on objects with appropriate difficulty. In the supervised contrastive learning in which targets are learned, a curriculum for batch sampling data for target representation learning is constructed based on a target with the highest current change rate in success rate according to the curriculum. In the early stage of learning, target data having a high success rate is sampled at a high rate to increase the amount of learning. Thereafter, as the learning of the corresponding target becomes saturated, the sampling rate for a difficult target increases gradually. In other words, more training data is allocated to a target with a higher change rate in success rate. Through TACS, sampling efficiency may be improved even in an under-explored target problem situation.

Third, there is applied Active Self-Querying (ASQ), which induces an agent to interact more frequently with an under-explored target. ASQ induces an agent to attempt to track more often a target that requires more experience or exploration. For the target states collected during learning, instructions are set for a target having a smaller proportion at a higher rate.

The present embodiment may provide high sampling efficiency and high success rate for multi-target tasks including an under-explored target through target representation learning, TACS, and ASQ.

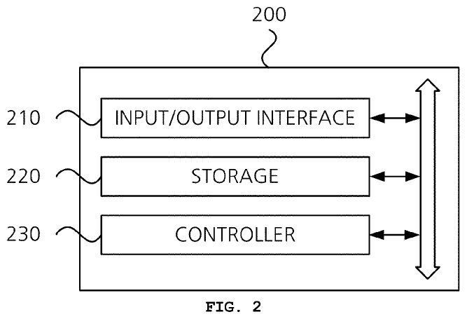

FIG. 2 is a function block diagram of a multi-target analysis apparatus 200 according to an embodiment.

Referring to FIG. 2, the multi-target analysis apparatus 200 according to the present embodiment includes an input/output interface 210, storage 220, and a controller 230.

The input/output interface 210 may include an input interface configured to receive input from a user and an output interface configured to display information such as the results of the performance of a task or the state of the multi-target analysis apparatus 200. In other words, the input/output interface 210 is a component that receives data and outputs the results of the computation of the data. The multi-target analysis apparatus 200 according to the present embodiment may receive an input target and a request for the analysis of the input target through the input/output interface 210.

The storage 220 is a component that stores files and programs, and may be formed of various types of memory. In particular, data and programs that allow the controller 230, to be described later, to perform operations for multi-target analysis according to an algorithm presented below may be stored in the storage 220. For example, the storage 220 may set up a target storage area.

The controller 230 is a component that includes at least one processor such as a central processing unit (CPU), a graphics processing unit (GPU), Arduino or the like, and may control the overall operation of the multi-target analysis apparatus 200. In other words, the controller 230 may control other components, included in the multi-target analysis apparatus 200, to perform an operation for multi-target analysis. The controller 230 may perform an operation for multi-target analysis according to an algorithm presented below by executing a program stored in the storage 220.

The controller 230 receives an instruction for a target and state information for the target and outputs action information by using a reinforcement learning-based learning model. The controller 230 adjusts the sampling rates of targets and instructions in a learning process so that an under-explored target is not excluded in a multi-target environment.

The controller 230 collects an instruction-target pair in which an instruction and state information for a target are matched with each other so that the target is specified through the instruction. The controller 230 generates an instruction-target set having a plurality of instruction-target pairs. The storage 220 records the instruction-target set in the target storage area.

The controller 230 trains a reinforcement learning-based learning model that receives an instruction for a target and state information for the target and then outputs action information.

An operation in which the multi-target analysis apparatus 200 trains a reinforcement learning-based learning model will be described below.

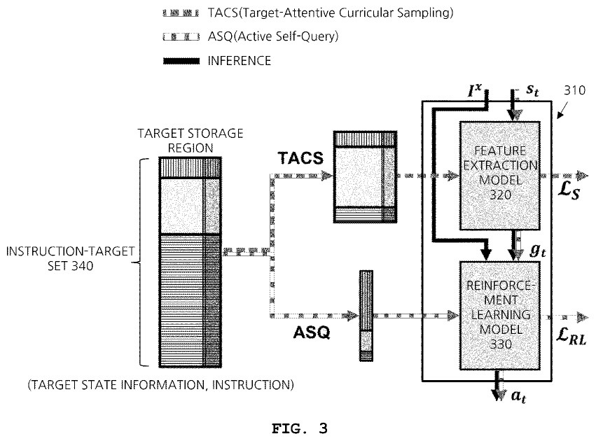

FIG. 3 is a diagram illustrating the operation and data flow of a reinforcement learning-based learning model applied to a multi-target analysis apparatus according to an embodiment.

A reinforcement learning-based learning model 310 includes a feature extraction model 320 and a reinforcement learning model 330. The feature extraction model 320 is a model that receives state information for a target and outputs state feature information. The reinforcement learning model 330 is a model that is connected to the feature extraction model 320 and receives an instruction and state feature information for the target and outputs action information. The reinforcement learning model 330 receives the state feature information from the feature extraction model 320.

The multi-target analysis apparatus 200 collects data by collecting state data when a success is made through trial and error during learning and then labeling an instruction. The collected data is an instruction-target pair in which the instruction and the target state information are matched with each other, and a plurality of instruction-target sets 340 are stored in the target storage area. The collected data together with a reinforcement learning policy are learned together.

In an inference process, an instruction I^{x} and a state Sₜ are input to the reinforcement learning-based learning model 310, and an action aₜ is output. The reinforcement learning-based learning model 310 utilizes TACS and ASQ in a learning process. TACS and ASQ help learning in such a manner that TACS adjusts the sampling rate of target states in the learning process of the feature extraction model 320 and ASQ controls the ratio of queries in the learning process of the reinforcement learning model 330.

The reinforcement learning model 330 for multiple targets defines tuples S, [symbol] , [symbol] , [symbol] , γ, and [symbol] based on a probability model called a Markov decision process (MDP). S denotes a state space, [symbol] denotes an action space, [symbol] denotes a reward function, [symbol] denotes a transition probability function, and γ denotes a discount factor. [symbol] denotes an instruction set. For N targets, an instruction set [symbol] ={I¹, I², . . . , I^{N}} is determined at the beginning of an episode. An instruction I^{x} determines the reward function of a target x for the execution of a particular policy, but does not change a transition probability.

In a state value function V(s,I^{x} )=V(s^{x})= [symbol] [Rₜ|sₜ^{x}=(s, x)], sₜ^{x} is a state condition for the target x, and Rₜ denotes the sum of damped rewards from an initial stage t to an end stage T.

The reinforcement learning model 330 may apply Asynchronous Advantage Actor-Critic (A3C) as a multi-target reinforcement learning algorithm. The A3C algorithm uses an agent, called a plurality of actor-learners, to collect samples. The individual actor-learners each constructed of the same neural network model generate samples while acting asynchronously for a predetermined period in different environments. A neural network model is trained using samples generated by the plurality of actor-learners, and the trained neural network model is copied back into the actor-learners.

A policy gradient for an actor function and a loss gradient for a critic function are defined as the following Equations 1 and 2, respectively:

∇_{θ} [symbol] _{RL}=−∇_{θ} log π_{θ}(aₜ|sₜ^{x})(Rₜ−V_{ϕ}(sₜ^{x})−β∇H(π_{θ}(·|sₜ^{x})) (1)

∇_{ϕ} [symbol] _{RL}=∇_{ϕ}(Rₜ−V_{ϕ}(sₜ^{x})² (2)

In Equation 1, H denotes an entropy term, and β denotes a coefficient. A loss function for reinforcement learning [symbol] _{RL} is minimized to update the actors and critics of the reinforcement learning agent.

The learning method of non-patent document 1 applies representation learning to help an agent discriminate targets. Cross entropy is used for the representation learning of the encoding features acquired through a feature extractor with RGB-D observations used as input. The learning method of non-patent document 1 acquires an action from a policy based on a feature and performs learning by using Equation 3. Equation 3 is defined as a final loss function obtained by adding a loss function for representation learning [symbol] _{Rep} (to which coefficient η is applied) to the loss function for reinforcement learning [symbol] _{RL}.

[symbol]

ₜₒₜₐₗ= [symbol] _{RL}+η [symbol] _{Rep} (3)

The learning method of non-patent document 1 has a problem in that an under-explored target is rarely collected for multiple targets having different success rates, and requires the prior knowledge of an overall target class and at least one data collection for each target.

The multi-target analysis apparatus 200 according to the present embodiment stores the instruction I^{x} of the episode for the target x. When the successful execution of the instruction is identified, an instruction-target pair in which the target state information and the instruction are matched with each other is stored in the training process. The multi-target analysis apparatus 200 may utilize the stored instruction-target pair as a data set in a representation learning process. The multi-target analysis apparatus 200 may collect target-related data from reward information by using an instruction-target set having a plurality of instruction-target pairs.

The multi-target analysis apparatus 200 extracts target features through auxiliary learning-based representation learning. Auxiliary learning is a method of making a main task to be learned in one deep learning model, together with the information obtained directly or indirectly when the main task is performed, into output and then learning the information together with the main task. Additional gradients help the main task be learned by learning a deep layer of the model or learning additional information.

The multi-target analysis apparatus 200 performs a task through target representation learning and responds to unbalanced target data. The feature extraction model 320 performs representation learning and may apply supervised contrastive learning. For supervised contrastive learning, reference may be made to non-patent document 3 (Khosla, Prannay, et al. “Supervised contrastive learning.” Advances in Neural Information Processing Systems 34 (2020)).

In supervised contrastive learning, representation learning may be possible regardless of the number of classes by using the same label data as a positive pair. The multi-target analysis apparatus 200 treats each instruction as a label for a target state by using an instruction-target pair stored in the target storage area. Data corresponding to the same target is treated as a positive pair, and data corresponding to different targets is treated as a negative pair. The feature extraction model 320 extracts features for targets based on positive pairs and negative pairs.

A loss function for target representation learning is represented by Equation 4 below:

$${ℒ}_{S} = {\sum }_{j ∈ J} \frac{- 1}{\vert P ( j ) \vert} {\sum }_{p ∈ P ( j )} log \frac{exp ( {g}_{j} \cdot {g}_{p} / {τ}_{s} )}{{\sum }_{h ∈ J \backslash \{ j \}} exp ( {g}_{j} \cdot {g}_{h} / {τ}_{s} )} \qquad ( 4 )$$

where J denotes the overall index set of target states in batch data, P(j) denotes a positive data set corresponding to a j-th target state, |P(j)| denotes the cardinality of P(j), gⱼ denotes the feature vector of a j-th target state output through the feature extraction model 320, and τₛ denotes a hyperparameter (e.g., temperature, or the like).

The total loss function for performing the task is represented by Equation 5 obtained by replacing [symbol] _{Pep} with [symbol] _{S} in Equation 3, as shown below:

[symbol]

ₜₒₜₐₗ= [symbol] _{RL}+η [symbol] _{S} (5)

The policy is updated through the sum of the loss function of the reinforcement learning policy and the loss function of the feature extraction model. Through the multiplication of coefficient η, the weight of the target state is lowered and the learning of the policy is helped.

An operation in which the multi-target analysis apparatus 200 performs TACS and ASQ in a learning process will be described below.

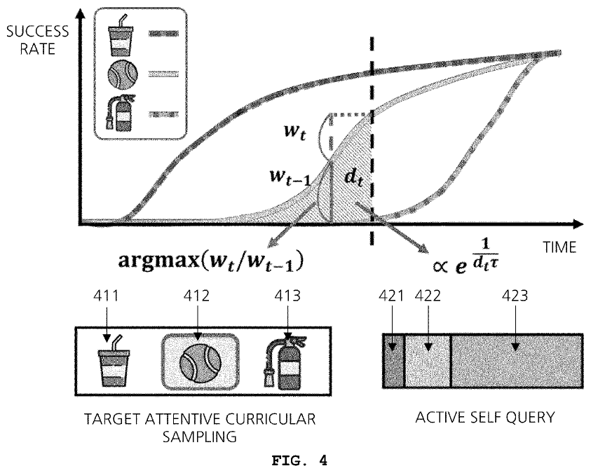

FIG. 4 is a diagram illustrating TACS and ASQ that are performed by a multi-target analysis apparatus according to an embodiment.

The multi-target analysis apparatus 200 shares a target storage area when performing TACS and ASQ. The multi-target analysis apparatus 200 refers to instruction-target sets stored in the target storage area in a reinforcement learning process.

TACS is a method of adjusting the composition proportion of batch data in supervised contrastive learning, and adjusts the ratio between collected target states for individual labels according to a learning situation.

For example, referring to FIG. 4, in a situation in which three targets related to a cup 411, a ball 412, and a fire extinguisher 413 are learned, a success rate is measured for each of the targets, and the composition proportion of a target having the highest success rate per unit of measure is increased.

Through TACS, the success rate for each target changes dramatically and steeply according to learning, then saturation occurs, and learning proceeds intensively with a target having the next lowest difficulty level. When a focused target is selected, the fact that the success rate of each target increases rapidly when learning begins, the fact that the time at which focused learning starts varies depending on the difficulty level of a target, and the fact that the success rate is saturated and the rate of change decreases for the targets for which the agent has actually completed learning are taken into consideration.

TACS determines a focused target to be focused on learning by using Equation 6 below:

$${\tilde{x}}_{t} = arg {max}_{x} {\sum }_{x ∈ 𝒳} {w}_{t}^{x} / {w}_{t - 1}^{x} \qquad ( 6 )$$

In this equation, X denotes a total target class set, and wₜ^{x} denotes the success rate of the target x at a t-th update time point. In a t-th update, a target having a relative large increase in success rate is selected. In the update of the feature extraction model 320, the representation learning of a focused target is improved by performing sampling at a higher rate.

The sampling rate Bₜ(x) for each target x used to update the feature extraction model 320 is represented as in Equation 7 below:

$${B}_{t} ( x ) = m \times {{\tilde{x}}_{t} = x}_{} + \frac{1 - m}{N} \qquad ( 7 )$$

where N is the number of target classes, m (m≤1) is a hyperparameter that determines the ratio between the focused target and uniform sampling, and [symbol] is an indicator function.

TACS increases the sampling rate of an easy target that can be initially collected. Thereafter, when saturation is reached, the main sampling rate is shifted for a target having the next lowest difficulty level, so that ultimately a difficult target may be efficiently learned. The focused target is determined based on changes in success rate, and learning is performed from an easy target to a difficult target. TACS improves learning efficiency by performing curriculum learning in order of difficulty level.

ASQ allows instructions to be set in a learning process in such a manner as to increase the number of explorations for a target requiring learning, thereby allowing an agent to attempt to explore a target requiring learning on its own. This is a kind of self-querying. In a multi-target task, one target is specified through an instruction I^{x}. ASQ increases exploration attempts by setting the instruction I^{x} for an under-exploded target.

ASQ increases the number of explorations for a smaller proportion through the inverse function of the composition proportion of target state information in the target storage area. ASQ may calculate the composition proportion of an instruction through Equation 8 below:

$$A ( x ) = \frac{{exp ( ( {d}^{x} \times {τ}_{a} \}}^{- 1} )}{{\sum }_{{x}^{′} ∈ 𝒳} exp ( {\{ {d}^{{x}^{′}} \times {τ}_{a} \}}^{- 1} )} \qquad ( 8 )$$

In this equation, d^{x} is the amount of target x stored in the target storage area, and τₐ is a hyperparameter (e.g., temperature, or the like), in which case as the value decreases, the sensitivity becomes higher. The instruction I^{x} is determined multinomially by the proportion obtained through A(x).

ASQ makes the amount of target data have a smaller proportion than the total amount of instruction-target set by using the inverse exponent. For example, referring to FIG. 4, the composition proportion 421 of instructions related to the cup, the composition proportion 422 of instructions related to the ball, and the composition proportion 423 of instructions related to the fire extinguisher are adjusted.

ASQ may prevent a target having a high difficulty level from being substantially neglected through a method of setting instructions so that a target having a smaller proportion collected in the target storage area has a larger proportion for instructions.

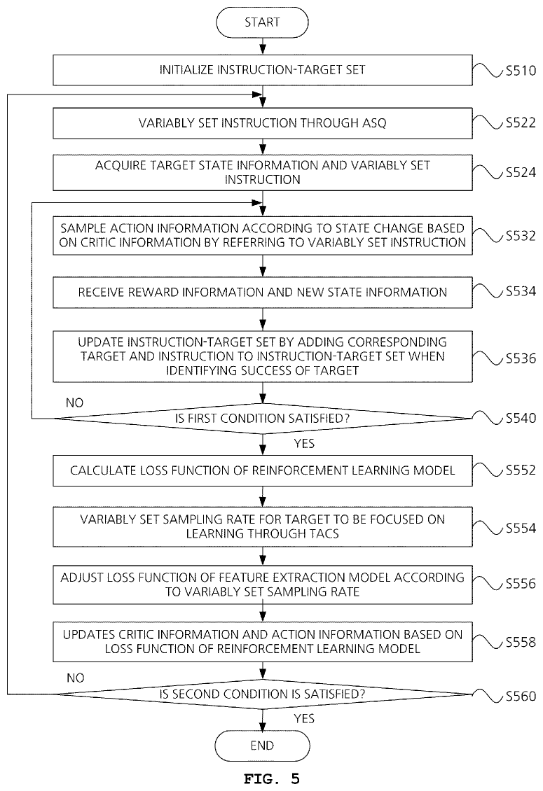

FIG. 5 is a flowchart illustrating an overall learning operation that is performed by a multi-target analysis apparatus according to an embodiment.

In step S510, the multi-target analysis apparatus 200 initializes an instruction-target set. The instruction-target set may be initialized to the data selected as desired, and the data collected through trial and error may be used for the initialization.

In step S522, the multi-target analysis apparatus 200 variably sets an instruction through ASQ. In step S524, the multi-target analysis apparatus 200 acquires target state information and a variably set instruction.

In step S532, the multi-target analysis apparatus 200 samples action information according to the state change based on critic information by referring to the variably set instruction. In step S534, the multi-target analysis apparatus 200 receives reward information and new state information.

In step S536, when the multi-target analysis apparatus 200 identifies the success of a target, it updates the instruction-target set by adding the corresponding target and instruction to the instruction-target set.

In step S540, the multi-target analysis apparatus 200 determines whether a first condition is satisfied, and performs step S552 when the first condition is satisfied and repeats the previous steps starting from step S532 again when the first condition is not satisfied. The first condition may be set to a condition in which the reception of target state information is terminated or a condition in which execution time is exceeded.

In step S552, the multi-target analysis apparatus 200 calculates the loss function of the reinforcement learning model. In step S554, the multi-target analysis apparatus 200 variably sets a sampling rate for a target to be focused on learning through TACS. In step S556, the multi-target analysis apparatus 200 adjusts the loss function of the feature extraction model according to the variably set sampling rate. In step S558, the multi-target analysis apparatus 200 updates critic information and action information based on the loss function of the reinforcement learning model. The loss function of the feature extraction model and the loss function of the reinforcement learning model may be applied together in the process of updating the critic information and the action information.

In step S560, the multi-target analysis apparatus 200 determines whether a second condition is satisfied, and ends the process when the second condition is satisfied and repeats the previous steps starting from step S522 again when the second condition is not satisfied. The second condition may be set to a condition in which a predetermined number of episodes end.

An algorithm for the overall learning operation of the multi-target analysis apparatus may be represented in pseudocode, as shown in Table 1:

```
TABLE 1
Initialize actor and critic parameters π and θ
Initialize SupCon parameters: θₛ
Goal Storage: [symbol] g ← ø
Global shared counter: T ← 0
Thread step count: t ← 1
repeat
  a ~ Random action [symbol]
  g ← [symbol] g ∪ {(sₜ, one_hot(I))}
until | [symbol]  g| > twarm
repeat
  tₛₜₐᵣₜ ← t
  Get state sₜ, Instruction I = ASQ( [symbol] g) in Eq. 8
  repeat
    aₜ ~ π(aₜ|sₜ, I; θ)
    Receive reward τₜ and new state sₜ₊₁
    if Success then [symbol]
      g ← [symbol] g ∪ {(sₜ, one_hot(I))}
    end if
    t ← t + 1
    T ← T + 1
until terminal sₜ or t − tₛₜₐᵣₜ = tₘₐₓ
for i ϵ {t − 1, ..., tstart} do
    Calculate dθ, dπ with Eq. 1 and 2
  end for
  B = TACS( [symbol] g) in Eq. 7
  θs ← θs − η∇θs [symbol]  ₍s_{,}I₎ ~ B[∇θg [symbol] S ] in Eq. 4
  Perform asynchronous update of π using dπ and of θ
  using dθ.
until T > Tₘₐₓ
```

The parameter π of the actor and the parameter θ of the critic applied to the reinforcement learning-based learning model are initialized. The parameter θₛ applied to the feature extraction model is initialized. The instruction-target set [symbol] _{g} of the target storage area is initialized. The global shared counter T and the thread step counter t are initialized.

The process of updating the instruction-target set based on the hyperparameter t_{warm} related to the cardinality | [symbol] _{g}| of the instruction-target set of the target storage area is repeated.

The reinforcement learning process is repeated based on the maximum global shared counter Tₘₐₓ such as the predetermined number of episodes.

In the reinforcement learning process, an instruction is variably set by performing ASQ using Equation 8, and target state information and a variably set instruction are acquired.

In the reinforcement learning process, the following operations are repeated based on the termination of state information or the maximum thread step counter tₘₐₓ. There are repeated the operation of sampling action information according to the state change based on critic information by referring to the variably set instruction, the operation of receiving reward information rₜ and new state information sₜ₊₁, and the operation of updating an instruction-target set with a corresponding target and instruction when the success of the target is identified.

In the reinforcement learning process, the loss function of the reinforcement learning model (the policy gradient dπ of the actor function and the loss gradient dθ of the critic function) is calculated using Equations 1 and 2. A sampling rate for a target to be focused on learning through TACS is variably set using Equation 7. The loss function of the feature extraction model is adjusted according to the variably set sampling rate by using Equation 4. Based on the loss function of the reinforcement learning model (the policy gradient dπ of the actor function and the loss gradient dθ of the critic function), the parameter π of the actor and the parameter 0 of the critic are asynchronously updated. In the process of asynchronously updating the parameter π of the actor and the parameter θ of the critic, the loss function of the reinforcement learning model and the loss function of the feature extraction model may be applied together.

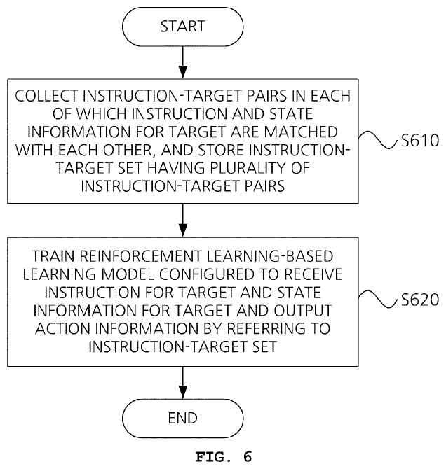

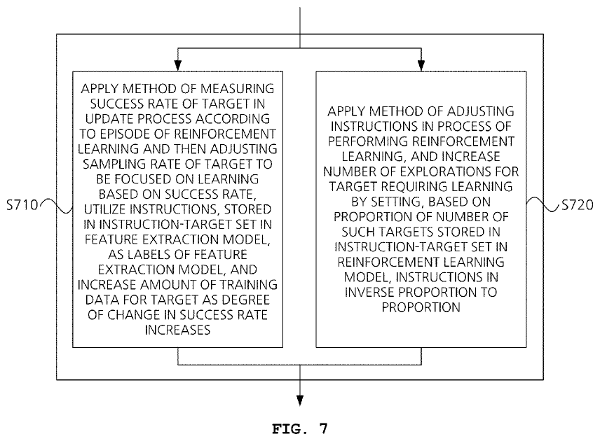

FIGS. 6 and 7 are flowcharts illustrating a multi-target analysis method according to another embodiment.

The multi-target analysis method according to the embodiments shown in FIGS. 6 and 7 includes steps that are performed in a time-series manner by the multi-target analysis apparatus shown in FIG. 2. Accordingly, the descriptions that are omitted below but have been given above in conjunction with the multi-target analysis apparatus shown in FIG. 2 may also be applied to the multi-target analysis method according to the embodiments shown in FIGS. 6 and 7.

In step S610, the multi-target analysis apparatus 200 collects an instruction-target pair in which an instruction and state information for a target are matched with each other so that the target is specified through the instruction, and stores an instruction-target set having a plurality of instruction-target pairs.

In step S620, the multi-target analysis apparatus 200 trains a reinforcement learning-based learning model configured to receive an instruction for a target and status information for the target and output action information by referring to the instruction-target set.

Steps S710 and S720 are more specific embodiments of step S620.

In step S710, the multi-target analysis apparatus 200 applies a method of measuring the success rate of each target in an update process according to an episode of reinforcement learning and then adjusting a sampling rate for a target to be focused on learning based on the success rate. In step S710, the multi-target analysis apparatus 200 utilizes the instructions, stored in the instruction-target set in the feature extraction model, as labels of the feature extraction model, and increases the amount of training data for a target as the degree of change in the success rate increases.

In step S720, the multi-target analysis apparatus 200 applies a method of adjusting instructions in a reinforcement learning process. In step S720, the multi-target analysis apparatus 200 increases the number of explorations for a target requiring learning by setting, based on a proportion of the number of such targets stored in the instruction-target set in the reinforcement learning model, the instructions in inverse proportion to the proportion.

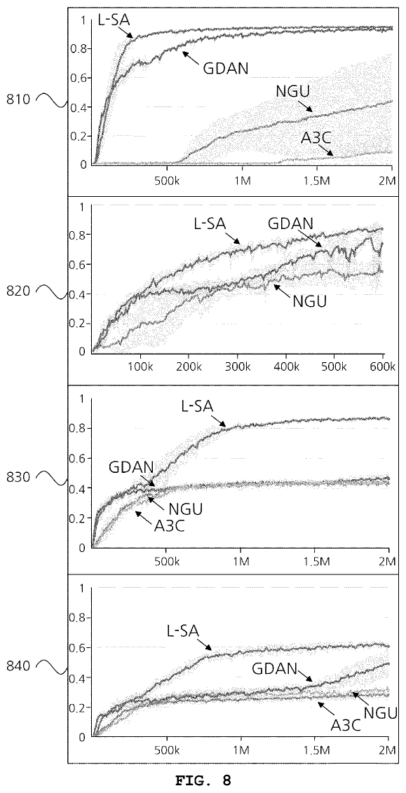

FIGS. 8 to 10 are diagrams illustrating success rates of multiple targets simulated according to embodiments. The x-axis represents the number of updates, and the y-axis represents the success rate of the target.

FIG. 8 is a diagram showing all success rates in a multi-target environment.

Reference numeral 810 denotes all success rates in an environment in which an agent was located at the center of a map and four targets were generated at random locations throughout the map. Reference numeral 820 denotes all success rates in an environment in which one normal target and one difficult target were generated, in which case the difficult target was located farther than a predetermined distance from an agent. Reference numeral 830 denotes all success rates in an environment in which two normal targets and two difficult targets were generated. Reference numeral 840 denotes all success rates in an environment in which two normal targets and two difficult targets were generated in a maze.

It can be seen that L-SA (Learning, Sampling, Active self-querying), which was an example, was trained before GDAN (Goal-Discriminative Attention Networks; Kim et al. 2021), NGU (Never Give Up; Badia et al. 2020), and A3C (Asynchronous Advantage Actor Critic; Wu et al. 2018), which were comparative examples, and exhibited the highest success rate. In particular, referring to reference numerals 830 and 840, the success rate was almost twice as high.

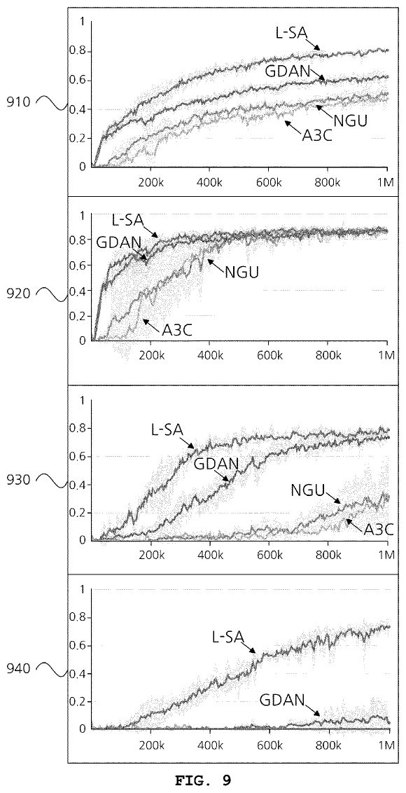

FIG. 9 is a diagram showing success rates for respective targets according to the difficulty level in a multi-target environment.

Reference numeral 910 denotes all success rates in an environment in which two normal targets, one target having an intermediate difficulty level, and one target having a high difficulty level were generated. Reference numeral 920 denotes the success rates for the normal targets. Reference numeral 930 denotes the success rates for the target having an intermediate difficulty level. Reference numeral 940 denotes the success rates for the target having a high difficulty level.

It can be seen that L-SA, which was an example, exhibited the highest success rates for all difficulty levels compared to GDAN, NGU, and A3C, which were comparative examples. In particular, referring to reference numeral 940, the comparative examples do not perform the collection and learning of an under-explored target for a target having a high difficulty level. In contrast, in the example, it can be seen that learning was possible for an under-explored target having a high difficulty level.

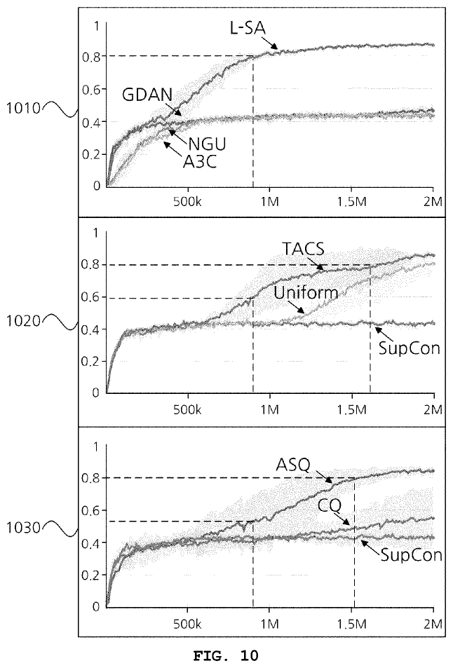

FIG. 10 is a diagram related to single performance analysis (ablation study) for sampling or querying.

Reference numeral 1010 denotes all success rates in an environment in which two normal targets and two difficult targets were generated. Reference numeral 1020 denotes the results of single performance analysis for sampling. Reference numeral 1030 denotes the results of single performance analysis for querying.

Referring to reference numeral 1020, it can be seen that TACS designed to adjust the sampling rate according to the difficulty level had a higher success rate than Uniform designed to perform uniform sampling and SupCon (Khosla et al. 2020) designed to perform random sampling, which were comparative examples.

Referring to reference numeral 1020, it can be seen that ASQ designed to adjust querying according to the proportion of a target exhibited a higher success rate than CQ (Curricula Querying) designed to perform querying according to the curriculum and SupCon designed to perform random querying, which were comparative examples.

Referring to reference numeral 1010, it can be seen that sampling efficiency according to the episode was further improved in the case where TACS and ASQ were applied together than in the cases where TACS or ASQ was applied alone.

The present embodiment may optimize the performance and efficiency of learning by appropriately adjusting a sampling/querying rate according to the learning situation in a multi-target environment.

The present embodiment may be utilized in the fields where various multi-target tasks are performed, such as the navigation, service robot, industrial robot, driving robot, and logistics robot fields.

The term “unit” used in the above-described embodiments means software or a hardware component such as a field-programmable gate array (FPGA) or application-specific integrated circuit (ASIC), and a “unit” performs a specific role. However, a “unit” is not limited to software or hardware. A “unit” may be configured to be present in an addressable storage medium, and also may be configured to run one or more processors. Accordingly, as an example, a “unit” includes components, such as software components, object-oriented software components, class components and task components, processes, functions, attributes, procedures, subroutines, segments in program code, drivers, firmware, microcode, circuits, data, a database, data structures, tables, arrays, and variables.

The functions provided in components and “unit(s)” may be combined into a smaller number of components and “unit(s)” or divided into a larger number of components and “unit(s).”

In addition, components and “unit(s)” may be implemented to run one or more central processing units (CPUs) in a device or secure multimedia card.

The multi-target analysis method according to the embodiment descried through the present specification may be implemented in the form of a computer-readable medium that stores instructions and data that can be executed by a computer. In this case, the instructions and the data may be stored in the form of program code, and may generate a predetermined program module and perform a predetermined operation when executed by a processor. Furthermore, the computer-readable medium may be any type of available medium that can be accessed by a computer, and may include volatile, non-volatile, separable and non-separable media. Furthermore, the computer-readable medium may be a computer storage medium. The computer storage medium may include all volatile, non-volatile, separable and non-separable media that store information, such as computer-readable instructions, a data structure, a program module, or other data, and that are implemented using any method or technology. For example, the computer storage medium may be a magnetic storage medium such as an HDD, an SSD, or the like, an optical storage medium such as a CD, a DVD, a Blu-ray disk or the like, or memory included in a server that can be accessed over a network.

Furthermore, the multi-target analysis method according to the embodiment descried through the present specification may be implemented as a computer program (or a computer program product) including computer-executable instructions. The computer program includes programmable machine instructions that are processed by a processor, and may be implemented as a high-level programming language, an object-oriented programming language, an assembly language, a machine language, or the like. Furthermore, the computer program may be stored in a tangible computer-readable storage medium (for example, memory, a hard disk, a magnetic/optical medium, a solid-state drive (SSD), or the like).

Accordingly, the multi-target analysis method according to the embodiment descried through the present specification may be implemented in such a manner that the above-described computer program is executed by a computing apparatus. The computing apparatus may include at least some of a processor, memory, a storage device, a high-speed interface connected to memory and a high-speed expansion port, and a low-speed interface connected to a low-speed bus and a storage device. These individual components are connected using various buses, and may be mounted on a common motherboard or using another appropriate method.

In this case, the processor may process instructions within a computing apparatus. An example of the instructions is instructions which are stored in memory or a storage device in order to display graphic information for providing a Graphic User Interface (GUI) onto an external input/output device, such as a display connected to a high-speed interface. As another embodiment, a plurality of processors and/or a plurality of buses may be appropriately used along with a plurality of pieces of memory. Furthermore, the processor may be implemented as a chipset composed of chips including a plurality of independent analog and/or digital processors.

Furthermore, the memory stores information within the computing device. As an example, the memory may include a volatile memory unit or a set of the volatile memory units. As another example, the memory may include a non-volatile memory unit or a set of the non-volatile memory units. Furthermore, the memory may be another type of computer-readable medium, such as a magnetic or optical disk.

In addition, the storage device may provide a large storage space to the computing device. The storage device may be a computer-readable medium, or may be a configuration including such a computer-readable medium. For example, the storage device may also include devices within a storage area network (SAN) or other elements, and may be a floppy disk device, a hard disk device, an optical disk device, a tape device, flash memory, or a similar semiconductor memory device or array.

According to any one of the above-described solutions, there may be proposed the multi-target analysis method and apparatus capable of flexibly dealing with the types and number of all targets without determining them before starting learning.

According to any one of the above-described solutions, there may be proposed the multi-target analysis method and apparatus capable of performing focused learning by increasing a composition proportion in batch data for a target having a high degree of change in success rate.

According to any one of the above-described solutions, there may be proposed the multi-target analysis method and apparatus capable of improving the success rates of multiple targets by increasing the number of attempts by an agent for a target requiring learning.

The effects that can be obtained by the embodiments disclosed herein are not limited to the effects described above, and other effects not described above will be clearly understood by a person having ordinary skill in the art, to which the present invention pertains, from the foregoing description.

The above-described embodiments are intended for illustrative purposes. It will be understood that those having ordinary knowledge in the art to which the present invention pertains can easily make modifications and variations without changing the technical spirit and essential features of the present invention. Therefore, the above-described embodiments are illustrative and are not limitative in all aspects. For example, each component described as being in a single form may be practiced in a distributed form. In the same manner, components described as being in a distributed form may be practiced in an integrated form.

The scope of protection pursued through the present specification should be defined by the attached claims, rather than the detailed description. All modifications and variations which can be derived from the meanings, scopes and equivalents of the claims should be construed as falling within the scope of the present invention.

What is claimed is:

1. A multi-target analysis apparatus comprising:
an input/output interface configured to receive data and output results of computation of the data;
storage configured to store a program for performing a multi-target analysis method; and
a controller provided with at least one process, and configured to analyze multiple targets received through the input/output interface by executing the program;
wherein the controller is further configured to:
collect instruction-target pairs in each of which an instruction and state information for a target are matched with each other so that the target is specified through the instruction, and generate an instruction-target set having a plurality of instruction-target pairs; and
train a reinforcement learning-based learning model configured to receive the instruction for the target and the state information for the target and output action information by referring to the instruction-target set.

2. The multi-target analysis apparatus of claim 1, wherein the reinforcement learning-based learning model includes:
a feature extraction model configured to receive the state information for the target and output state feature information; and
a reinforcement learning model connected to the feature extraction model, and configured to receive the instruction for the target and the state feature information and output the action information.

3. The multi-target analysis apparatus of claim 2, wherein the controller applies a method of measuring a success rate of the target in an update process according to an episode of reinforcement learning and then adjusting a sampling rate of a target to be focused on learning based on the success rate, utilizes instructions, stored in the instruction-target set in the feature extraction model, as labels of the feature extraction model, and increases an amount of training data for the target as a degree of change in the success rate increases.

4. The multi-target analysis apparatus of claim 2, wherein the controller applies a method of adjusting the instructions in a process of performing reinforcement learning, and increases a number of explorations for a target requiring learning by setting, based on a proportion of a number of such targets stored in the instruction-target set in the reinforcement learning model, the instructions in inverse proportion to the proportion.

5. A multi-target analysis method that is performed by a multi-target analysis apparatus, the multi-target analysis method comprising:
collecting instruction-target pairs in each of which an instruction and state information for a target are matched with each other so that the target is specified through the instruction, and storing an instruction-target set having a plurality of instruction-target pairs; and
training a reinforcement learning-based learning model configured to receive the instruction for the target and the state information for the target and output action information by referring to the instruction-target set.

6. The multi-target analysis method of claim 5, wherein the reinforcement learning-based learning model includes:
a feature extraction model configured to receive the state information for the target and output state feature information; and
a reinforcement learning model connected to the feature extraction model, and configured to receive the instruction for the target and the state feature information and output the action information.

7. The multi-target analysis method of claim 6, wherein training the reinforcement learning-based learning model comprises applying a method of measuring a success rate of the target in an update process according to an episode of reinforcement learning and then adjusting a sampling rate of a target to be focused on learning based on the success rate, utilizing instructions, stored in the instruction-target set in the feature extraction model, as labels of the feature extraction model, and increasing an amount of training data for the target as a degree of change in the success rate increases.

8. The multi-target analysis method of claim 6, wherein training the reinforcement learning-based learning model comprises applying a method of adjusting the instructions in a process of performing reinforcement learning, and increasing a number of explorations for a target requiring learning by setting, based on a proportion of a number of such targets stored in the instruction-target set in the reinforcement learning model, the instructions in inverse proportion to the proportion.

9. A non-transitory computer-readable storage medium having stored thereon a program that, when executed by a processor, causes the processor to execute the multi-target analysis method set forth in claim 5.

10. A computer program that is executed by a multi-target analysis apparatus and stored in a non-transitory computer-readable storage medium in order to perform the multi-target analysis method set forth in claim 5.
